(19) United States
(12) Patent Application Publication
(10) Pub. No.: US 2004/0055299 A1
(43) Pub. Date: Mar. 25, 2004

(54) Method and device for operating an exhaust gas turbocharger

(75) Inventor: Olivier Bernard, Baden (CH)

Correspondence Address: BURNS DOANE SWECKER & MATHIS L L P, POST OFFICE BOX 1404, ALEXANDRIA, VA, 22313-1404, US

(73) Assignee: ABB Turbo Systems AG, Baden (CH)

(21) Appl. No.: 10/660,498

(22) Filed: Sep. 12, 2003

(30) Foreign Application Priority Data
Sep. 23, 2002 (EP) 2405822.4

(51) Int. Cl. F02B 33/44

(52) U.S. Cl. 60/611; 60/605.1

(57) ABSTRACT

A method for operating an exhaust gas turbocharger serving for charging an internal combustion engine, in which a main flow of a gas is supplied to a compressor (14) of the exhaust gas turbocharger via an intake line (26), is compressed in the compressor (14) and is led into an intake duct of the internal combustion engine via a compressor line. The gas quantity transferred to the combustion chambers of the internal combustion engine via the intake duct is regulated by means of a throttle valve (36) arranged between the compressor (14) and the combustion chambers. When a vacuum occurs in the region downstream of the compressor (14) between the compressor (14) and the throttle valve (36), as compared with the pressure in the intake line (26) upstream of the compressor (14), this vacuum is utilized in order to generate a bypass flow (B) which is branched off upstream of the compressor (14) from the main flow led by the compressor (14), flows around the compressor (14) from its side located upstream to its side located downstream and is returned into the main flow again downstream of the compressor (14) and upstream of the throttle valve (36).

### DESCRIPTION

1. Technical Field

The invention relates to the operation of an exhaust gas turbocharger. It relates particularly to a method for operating an exhaust gas turbocharger according to the features of the preamble of patent claim 1, to a device for carrying out this method according to the features of the preamble of patent claim 5 and to an exhaust gas turbocharger having such a device.

2. Prior Art

Exhaust gas turbochargers are used for the charging of internal combustion engines, a turbine, driven by the exhaust gas, of the exhaust gas turbocharger driving a compressor via a common shaft. The compressor sucks in, via an intake line, a gas, usually air or a mixture of air and of a gas, usually fuel gas and/or exhaust gas, and compresses this. Via a compressor line which is connected to the compressor downstream and is connected to an intake duct of the internal combustion engine, the compressed gas is supplied to combustion chambers of the internal combustion engine. With the aid of the compressed gas, more fuel can be burnt in the combustion chambers of the internal combustion engine than would be the case with normal aspirating engines, and therefore the performance of the internal combustion engine can be increased. The gas quantity supplied to the combustion chambers, together with other parameters, such as the setting and distribution of the fuel mixture and the ignition point, essentially codetermines the current performance of the internal combustion engine. This means that, for example, in the case of a load take-up during the starting or acceleration of the engine, as high a gas quantity as possible should be supplied and, during the throttling of the engine, the latter should, if possible, be operated with a reduced gas quantity. Typically, the gas quantity supplied to the combustion chambers of the internal combustion engine is regulated with the aid of a throttle valve which is arranged downstream of the compressor and upstream of the combustion chambers, as is, for example, shown in the article “New high efficiency high speed gas engine the 3MW class” in CIMAC Congress 1998 Copenhagen, page 1393, FIG. 9, or is described in MTZ Motortechnische Zeitschrift 50 [MTZ Engine Journal 50] (1989) 5, page 231, FIG. 7.

Just as, during the operation of the exhaust gas turbocharger, different pressures prevail in the intake line upstream of the compressor and in the flow-carrying lines downstream of the compressor, different pressures may also arise in the line segments upstream of the throttle valve and downstream of the throttle valve due to operation by means of the throttle valve. It has been shown, for example, that, during the throttling of the internal combustion engine, when the throttle valve is essentially closed, a vacuum prevails in the region downstream of the throttle valve, as compared with the pressure in the region upstream of the throttle valve. Under full load, then, the compressor usually delivers full power, so that the pressure in the region upstream of the throttle valve, that is to say between the compressor and the throttle valve, is normally also higher than the pressure upstream of the compressor in the intake line. In order, in the event of a sudden shedding of load, to eliminate these undesirable pressure conditions and obtain a rapid pressure reduction upstream of the throttle valve, various bypass lines have been proposed, which connect the region between the compressor and the throttle valve downstream of the compressor to the intake line upstream of the compressor and make it possible for the compressed gas to flow out of the region between the compressor and the throttle valve back into the intake line upstream of the compressor. Examples of such bypass lines are described in DE-A-28 23 067 and DE-A-197 28 850. So that the bypass line can be used in a controlled way, one or more bypass valves are provided in the bypass line. The control of these bypass valves functions essentially by pressure control. In this case, the pressure differences which occur are partially utilized directly by pressure valves, even pressures from the exhaust gas region of the system being taken into account. The control also partially takes place electronically, temperature, rotational speed and other data of the system also being taken into account in addition to the pressure data.

Even during acceleration out of the part load range into, for example, the full load range, unsatisfactory pressure conditions may be established in gas supply lines and exhaust gas discharge lines in the internal combustion engine/exhaust gas turbocharger system. For example, in the part load range with a small opening angle of the throttle valve, an unnecessarily high pressure occurs between the compressor and the throttle valve and reacts via the compressor on the turbine and brakes the latter. The braked turbine, in turn, causes a build-up of exhaust gas in the region between the combustion chambers and the turbine, thus reducing the efficiency of the internal combustion engine. In order to reduce this build-up and the associated high pressure upstream of the turbine, it is possible nowadays for the flow to pass around the turbine by means of a valve-controlled exhaust gas bypass line (waste gate). However, this leads to very sluggish acceleration of the exhaust gas turbocharger in the event of a load take-up. In order to achieve an improved response time of the sluggishly reacting turbocharger, it has been proposed, in U.S. Pat. No. 4,774,812 and DE-A-198 24 476, likewise to provide a bypass line for bypassing the compressor on the compressor side. In the part load range, a bypass flow is led from the intake line upstream of the compressor into the region between the compressor and the throttle valve downstream of the compressor, so that little gas to no gas at all flows through the compressor and the exhaust gas turbocharger idles, driven only by the turbine. The above-described braking action of the compressor is thereby eliminated. In the event of a sudden acceleration out of part load operation into, for example, full load operation, the bypass line is, by contrast, closed, and the compressor already running at relatively high speed can build up a corresponding boost pressure relatively quickly. Both in U.S. Pat. No. 4,774,812 and in DE-A-198 24 476, the control of the valves in the bypass line and in the line in which the compressor is arranged takes place electronically. For this purpose, the most diverse possible operating data of the turbocharger and the internal combustion engine, detected via sensors, are processed in a control unit and a corresponding control signal is transmitted to the valves in the two lines.

Presentation of the Invention

These electronic controls of the valves, such as are described in U.S. Pat. No. 4,774,812 and DE-A-198 24 476, are complicated and involve a high outlay and, because of the necessary sensors, are also costly.

The object of the invention is, therefore, to present a simple cost-effective method for operating an exhaust gas turbocharger, in which the charging efficiency of the exhaust gas turbocharger during the load take-up of the internal combustion engine is improved. Further, a technically very simple and therefore also cost-effective device for carrying out this method is presented.

This object is achieved by means of a method having the features of patent claim 1.

As in the methods described in U.S. Pat. No. 4,774,812 and DE-A-198 24 476, in the method according to the invention, a main flow of a gas is supplied via an intake line to a compressor of the exhaust gas turbocharger, is compressed in the compressor and is led via a compressor line into an intake duct of the internal combustion engine, the gas quantity transferred to combustion chambers of the internal combustion engine via the intake duct being regulated by means of a throttle valve arranged between the compressor and the combustion chambers. However, in contrast to the methods described in U.S. Pat. No. 4,774,812 and DE-A-198 24 476, according to the invention, when the vacuum occurs in the region downstream of the compressor between the compressor and the throttle valve, as compared with the pressure in the intake line upstream of the compressor, this vacuum is utilized in order to generate a bypass flow which flows around the compressor from its side located upstream to its side located downstream. In other words, the bypass flow is generated, utilizing the vacuum prevailing in the region between the compressor and the throttle valve, is branched off upstream of the compressor from the main flow led by the compressor and is returned to the main flow again downstream of the compressor between the compressor and the throttle valve.

By the vacuum being utilized in order to generate the bypass flow, this method can be carried out very simply and cost-effectively. The return of the bypass flow into the main flow upstream of the throttle valve allows an uncomplicated control in terms of the opening and closing of the bypass line.

By contrast, in the solution according to the invention, only the pressure ratio between the pressure p1 in the intake line and the pressure p2 in the region between the compressor and the throttle valve is relevant. During starting, and even during load take-up in the low load range, the pressure p1 in the intake line is higher than the pressure p2 between the compressor and the throttle valve, so that the bypass flow through the bypass line takes place in the direction of the main flow, around the compressor, toward the combustion chambers. This improves the charging efficiency not only during the starting of the internal combustion engine, but, above all, also considerably during load take-up in the low load range. In normal operation, the pressure p2 between the compressor and the throttle valve is higher than the pressure p1 in the intake line. In the solution according to the invention, therefore, irrespective of the pressure p3 in the region downstream of the throttle valve, a flow pressure in the direction of the intake line always prevails during normal operation. In the solution according to the invention, therefore, a simple pressure-controlled, nonreturn valve can be adopted instead of a complicated control for changing flow directions.

If the bypass flow is branched off from the main flow in the intake line downstream of a flowmeter, evidential data on the mass flow, which are important for setting the fuel mixture, are obtained via the flowmeter even with regard to the flow around the compressor. If the bypass flow is returned into the main flow again in the region of the compressor line, the exhaust gas turbocharger can be separated from the internal combustion engine in a very simple way, thus reducing the assembly costs.

This method can be carried out in a very simple way by means of a device according to the invention which can be connected to a conventional system consisting of an internal combustion engine and of an exhaust gas turbocharger. The conventional system of internal combustion engine and exhaust gas turbocharger has an exhaust gas turbocharger with a compressor driven via a turbine. Said compressor is flow-connected upstream to an intake line and downstream to a compressor line. The compressor line can be connected to an intake duct of the internal combustion engine to form a flow line, a throttle valve being provided in the flow line. The device according to the invention comprises a bypass line which, in the assembled state, is connected on its first side to the intake line upstream of the compressor and with its second side to the flow line between the compressor and the throttle valve. The bypass line is in this case designed in such a way that it allows only a flow around the compressor from the compressor side located upstream to the compressor side located downstream. This can be made possible in the simplest and most cost-effective way by the bypass line having provided in it at least one regulating element, for example a nonreturn valve, which allows a flow from the compressor side located upstream to the compressor side located downstream, but prevents a flow in the opposite direction. The nonreturn valve is designed as a pressure-sensitive valve and is acted upon from one side by the pressure p1 and from the other side by the pressure p2. This makes it possible to have a very simple automatically resulting control which is not susceptible to faults and moreover is still highly cost-effective. Possibilities for the configuration of such a nonreturn valve are, for example, a spring-assisted ball valve or disk valve. Depending on the geometry of the bypass line, it may be expedient to provide more than one nonreturn valve.

The device according to the invention may be provided in new turbochargers, but it is also suitable for the retrofitting of existing exhaust gas turbochargers.

If an exhaust gas turbocharger for charging an internal combustion engine is already provided with a device according to the invention, this is highly advantageous for assembly. The bypass line is then advantageously connected to the compressor line downstream of the compressor, so that, during assembly, it does not have to be connected separately to the intake duct of the internal combustion engine. Admittedly, it is also conceivable that the second side of the bypass line is not connected to the compressor line of the exhaust gas turbocharger, but is designed for connection to the intake duct of the internal combustion engine. In this case, the throttle valve must be arranged in the intake duct of the internal combustion engine, and, during assembly, the bypass line must also be connected upstream of the throttle valve to the intake duct of the internal combustion engine.

Internal combustion engines equipped with an exhaust gas turbocharger and having a device according to the invention achieve a higher charging efficiency both during starting and, above all, during any load take-up from idling, when the throttle valve is opened rapidly, and, as long as the pressure p2 is lower than the pressure p1, the still slowly rotating compressor acts as a throttle.

Further preferred embodiments are the subject matter of further dependent patent claims.

### BRIEF DESCRIPTION OF THE DRAWING

The subject of the invention is explained in more detail below with reference to a preferred exemplary embodiment illustrated in the accompanying drawing in which, purely diagrammatically:

FIG. 1 shows an exhaust gas turbocharger with a device according to the invention, connected to an internal combustion engine;

FIG. 2 shows part of a compressor side of an exhaust gas turbocharger in section along its longitudinal axis, with an integrated bypass line; and

FIG. 3 shows a further embodiment of an exhaust gas turbocharger with an integrated bypass line, in an illustration according to FIG. 2.

The reference symbols used in the drawings and their significance are listed in summary in the list of reference symbols. The embodiment described is one example of the subject of the invention and has no restrictive effect.

Ways of Implementing the Invention

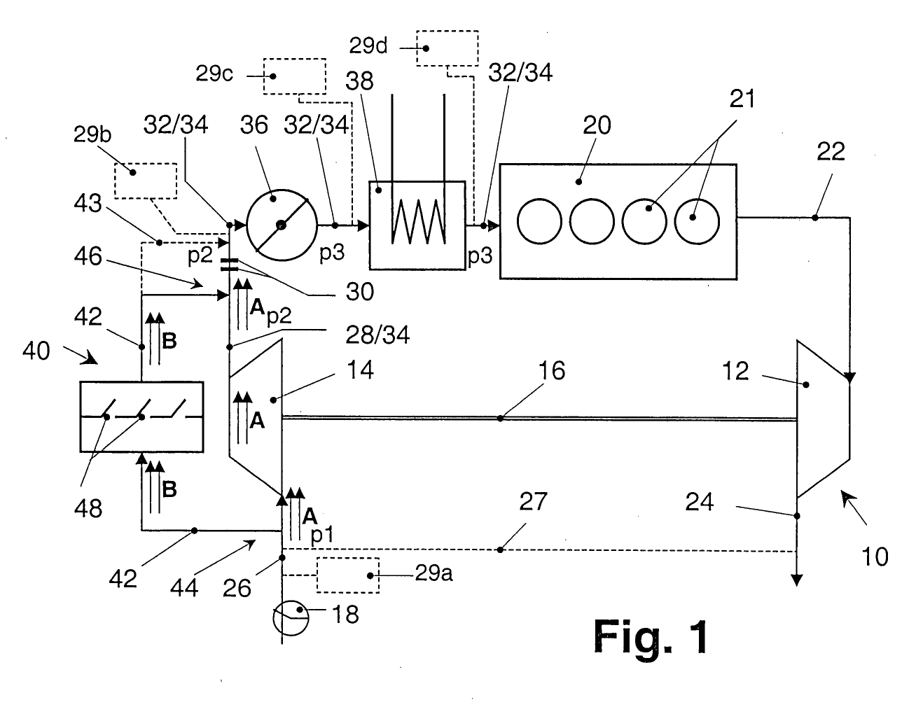

FIG. 1 shows an exhaust gas turbocharger 10 with a turbine 12 and with a compressor 14, the turbine 12 and the compressor 14 being arranged on a common shaft 16. An exhaust gas line 22 leads from an internal combustion engine 20 having combustion chambers 21 to the turbine 12. Exhaust gases are supplied to the turbine via the exhaust gas line 22 and drive the turbine 12 so that the compressor 14 also begins to operate via the common shaft 16. Exhaust gases are discharged downstream of the turbine 12 via a discharge line 24.

The compressor 14 draws in air under the pressure p1 via an intake line 26 arranged upstream. As indicated by the line 27 depicted by dashes, it is also possible to branch off part of the exhaust gas from the discharge line 24 by means of a connecting line and admix it, upstream of the compressor 14, to the air sucked in via the intake line. A fuel gas may also be admixed to the sucked-in air from a fuel gas container 29a, 29b, 29c, 29d. This admixing may take place both upstream 29a of the compressor 14 and at various locations downstream 29b, 29c, 29d of the compressor (in each case indicated by dashes). Sucked-in air and also an air/exhaust gas and air/fuel gas mixture or a mixture of air, fuel gas and exhaust gas are gases, and for this reason only gas will continue to be referred to. The sucked-in gas is led via the compressor 14, is compressed by the latter and is fed downstream into a compressor line 28. The compressor line 28 is connected to an intake duct 32 of the internal combustion engine 20 with the aid of a flanged connection 30. The compressor line 28 and the intake duct 32 together form a flow line 34 in which a throttle valve 36 is arranged. Although this is not generally customary, it is admittedly also conceivable that the throttle valve 36 is arranged in the compressor line 28 of the exhaust gas turbocharger 10 instead of in the intake duct 32 of the internal combustion engine 20. In the example shown here, a charge air cooler 38 is arranged downstream of the throttle valve 36. Downstream of the charge air cooler 38, the intake duct 32 is connected to the combustion chambers 21 of the internal combustion engine 20.

The exhaust gas turbocharger 10 has a device 40 according to the invention with a bypass line 42 which is connected on its first side 44 to the intake line 26 upstream of the compressor 14 and with its second side 46, downstream of the compressor, to the compressor line 28 between the compressor 14 and the throttle valve 36. It is, of course, also conceivable to connect the second side 46 of the bypass line 42 between the compressor 14 and the throttle valve 36 to the intake duct 32, instead of to the compressor line 28, as is indicated by the dashed line 43. The bypass line 42, 43 is equipped with simple nonreturn valves 48 which allow only a flow around the compressor 14 from the upstream side to the downstream side of the compressor 14. The nonreturn valves 48 open automatically when the ambient pressure p1 becomes higher than the pressure p2 prevailing in the region between the compressor 14 and the throttle valve 36. This occurs whenever the throttle valve 36 is opened completely, such as, for example, during the starting of the internal combustion engine 20; but, above all, also highly efficiently in the case of a load take-up from idling, because the slowly rotating compressor 14 then acts as a throttle.

Thus, whenever the pressure p1 in the intake line 26 is higher than the pressure p2 in the region between the compressor 14 and the throttle valve 36, the nonreturn valves 48 open due to the vacuum p2 downstream of the compressor 14, and a bypass flow B occurs, which is branched off from the main flow A upstream of the compressor 14. The bypass flow B diverted from the main flow A is led through the bypass line 42, 43 from the upstream side around the compressor 14 to the downstream side of the compressor 14 and is returned into the main flow A upstream of the throttle valve 36 and downstream of the compressor 14. If a flowmeter 18 is provided in the intake line 26, it is advantageous to branch off the bypass flow B from the main flow A in the intake line 26 downstream of the flowmeter 18. Evidential data on the mass flow is thereby obtained via the flowmeter 18 even in the case of the flow around the compressor.

It is, of course, conceivable to provide only one nonreturn valve 48 instead of the plurality of nonreturn valves 48 or to provide, instead of the nonreturn valve or nonreturn valves 48, one or more other regulating elements which allow the flow to pass through the bypass line 42, 43 only in the direction from the upstream side of the compressor 14 to the downstream side of the latter.

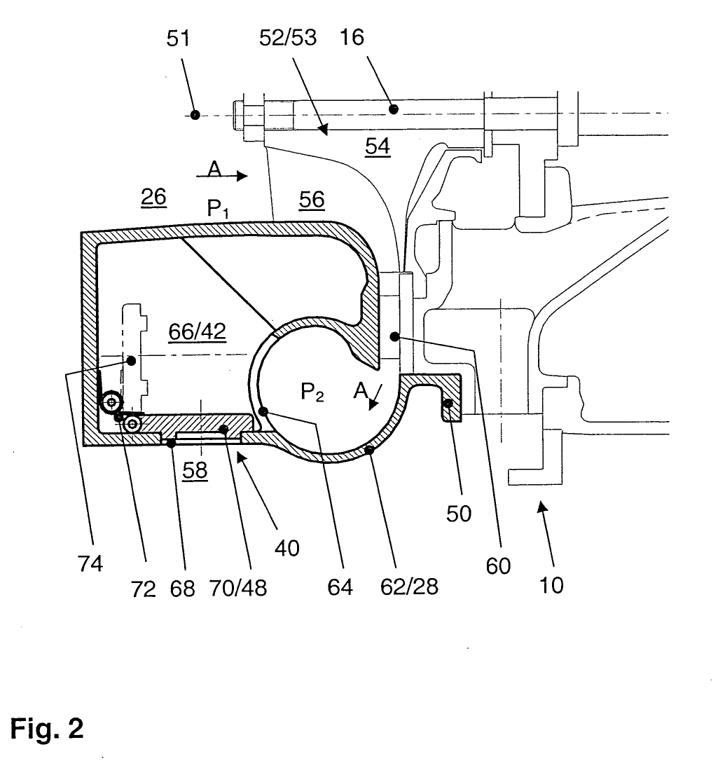

FIG. 2 shows part of the compressor side of an exhaust gas turbocharger 10 in section along the longitudinal axis 51 of the latter, in which the device 40 according to the invention is integrated into the casing 50 of the exhaust gas turbocharger 10. The compressor wheel 53, which is arranged with its hub 54 on the shaft 16, acts as the compressing element 52 in the compressor 14. The moving blades 56 of the compressor wheel 53 are fastened to the hub 54. Air, depicted as the main flow A, is sucked in via the intake line 26, which is connected to the surroundings 58, and is led via the compressor wheel 53 and a diffuser 60 into a spiral casing 62 of the compressor 14, said spiral casing being an integral part of the compressor line 28. In this case, the air is compressed from the ambient pressure p1 to the pressure p2. A connecting orifice 64 in the spiral casing 62 connects the spiral flow duct in the spiral casing 62 to a cavity 66 in the compressor-side part of the casing 50 of the exhaust gas turbocharger 10. The cavity 66 is connected to the surroundings 58 via a valve orifice 68 which is closed, by means of a flap 70 designed, in interaction with the valve orifice 64, as a nonreturn valve 48, as long as the ambient pressure p1 is lower than the pressure p2 in the spiral casing 62. If, however, a vacuum p2 prevails in the spiral casing 62, as compared with the ambient pressure p1, as occurs precisely in the case of a rapid load take-up from idling, then the flap 70 opens counter to the force of a spring 72, for example into the position 74 illustrated by dashes, and ambient air flows through the cavity 66 of the casing 50 until the pressures p1 and p2 are equal again or the pressure p2 is higher than the ambient pressure p1 again. The cavity 66 in the casing 50 thus serves, in this case, as a bypass line 42 for bypassing that element in the compressor 14 via which the sucked-in gas, air, is compressed. The cavity 66 thus serves for bypassing the compressor wheel 52 from the upstream side with the ambient pressure p1 to the downstream side with the pressure p2.

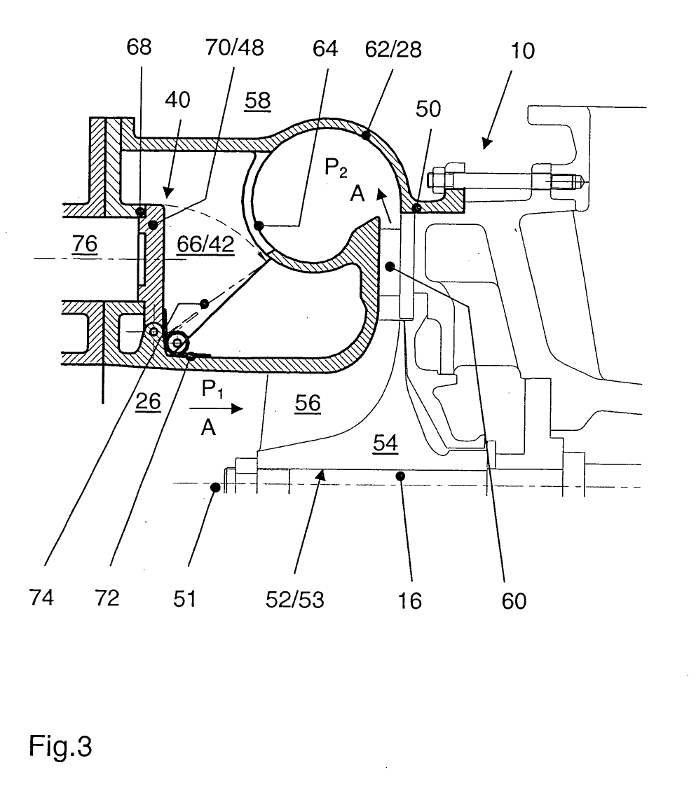

FIG. 3 shows a second example of such a bypass line 42 integrated in the casing 50 of the exhaust gas turbocharger 10. The construction is basically the same as in FIG. 2. However, the cavity 66 serving as a bypass line 42 is connected by means of the nonreturn valve 48, instead of directly to the surroundings 58, to a line 76 which, in turn, can be flow-connected (not illustrated) to the surroundings 58, to the intake line 26 and/or, for example, to the fuel gas container 29a and/or the connecting line 27.

If the bypass line 42 is integrated in the casing 50 of the exhaust gas turbocharger 10, then other nonreturn valves 48 or other mechanisms having the same action may be used instead of the simple flap device 70 with spring 72. So as not to influence the flow conditions in the spiral casing 62 adversely, the connecting orifice 64 in the spiral casing 62 may also be provided with a corresponding valve. The cavity 66 may also be designed as a duct incorporated in the casing and optimized in terms of flow, and the nonreturn valve or nonreturn valves may then be designed, for example, as ball valves. As described in FIG. 1, however, a bypass line 42 not integrated into the casing may also be used, this being especially suitable, in particular, for the retrofitting of existing systems.

List of Reference Symbols

| | |
|---|---|
| 10 | Exhaust gas turbocharger |
| 12 | Turbine |
| 14 | Compressor |
| 16 | Shaft |
| 18 | Flowmeter |
| 20 | Internal combustion engine |
| 21 | Combustion chamber |
| 22 | Exhaust gas line |
| 24 | Exhaust gas discharge line |
| 26 | Intake line |
| 27 | Connecting line |
| 28 | Compressor line |
| 29a, 29b, | Fuel gas container |
| 29c, 29d | |
| 30 | Flanged connection |
| 32 | Intake duct |
| 34 | Flow line |
| 36 | Throttle valve |
| 38 | Charge air cooler |
| 40 | Device |
| 42, 43 | Bypass line |
| 44 | First side |
| 46 | Second side |
| 48 | Regulating element, nonreturn valve |
| 50 | Turbocharger casing |
| 51 | Longitudinal axis of the exhaust gas turbocharger |
| 52 | Compressing element |
| 53 | Compressor wheel |
| 54 | Hub |
| 56 | Moving blade |
| 58 | Surroundings |
| 60 | Diffuser |
| 62 | Spiral casing |
| 64 | Connecting orifice |
| 66 | Cavity |
| 68 | Valve orifice |
| 70 | Flap |
| 72 | Spring |
| 74 | “Open” position |
| 76 | Line |

1. A method for operating an exhaust gas turbocharger serving for charging an internal combustion engine, in which a main flow of a gas is supplied to a compressor of the exhaust gas turbocharger via an intake line, is compressed in the compressor by means of a compressing element and is led via a compressor line into an intake duct of the internal combustion engine, the gas quantity transferred to combustion chambers of the internal combustion engine via the intake duct being regulated by means of a throttle valve arranged between the compressor and the combustion chambers, characterized in that, when a vacuum occurs in the region downstream of the compressing element (52) between the compressing element (52) and the throttle valve (36), as compared with the pressure in the intake line (26) upstream of the compressing element (52), this vacuum is utilized in order to generate a bypass flow (B) which is branched off upstream of the compressing element (52) from the main flow (A) led via the compressing element (52), flows around the compressing element (52) from its side located upstream to its side located downstream and is returned to the main flow (A) downstream of the compressing element (52) and upstream of the throttle valve (36).

2. The method as claimed in claim 1, characterized in that the bypass flow (B) is branched off from the main flow (A) in the intake line (26) downstream of a flowmeter (18) and/or is returned into the main flow (A) again in the region of the compressor line (28).

3. The method as claimed in claim 1 or 2, characterized in that, when the pressure conditions are reversed and excess pressure occurs in the intake line (26) in the region between the throttle valve (36) and the compressing element (52), as compared with the region upstream of the compressing element (52), a flow through the bypass line (42, 43) from the downstream side of the compressing element (52) to the upstream side of the latter is prevented.

4. The method as claimed in claim 3, characterized in that the flow through the bypass line (42, 43) from the downstream side of the compressing element (52) to the upstream side of the latter is prevented by means of at least one regulating element (48).

5. A device for operating an exhaust gas turbocharger, in which a compressor of the exhaust gas turbocharger is flow-connected upstream to an intake line and downstream to a compressor line, and the compressor line can be connected to an intake duct of an internal combustion engine to form a flow line, a throttle valve being provided in the flow line, comprising a bypass line which can be connected on its first side to the intake line upstream of a compressing element of the compressor and with its second side to the flow line downstream of the compressing element of the compressor, characterized in that, in the assembled state of the downstream-compressing element (52) of the compressor (14), the bypass line (42, 43) is connected to the flow line (34, 32, 28) between the compressing element (52) and the throttle valve (36), and in that said bypass line has at least one regulating element (48) which is designed in such a way that it allows only a flow around the compressing element (52) from its side located upstream to its side located downstream and prevents a flow from the downstream side of the compressing element (52) to the upstream side of the latter.

6. The device as claimed in claim 5, characterized in that the regulating element (48) is pressure-controlled, and preferably only the pressure in the intake line (26) in the region upstream of the compressing element (52) and the pressure in the region between the compressing element (52) and the throttle valve (36) are used for the control.

7. The device as claimed in one of claims 5 or 6, characterized in that the bypass line (42, 43) is integrated into a turbocharger casing (50).

8. An exhaust gas turbocharger for charging an internal combustion engine, the compressor of which is flow-connected upstream to an intake line and downstream to a compressor line, the compressor line being connectable to an intake duct of an internal combustion engine to form a flow line, and a throttle valve being provided in the flow line, comprising a bypass line which is connected on its first side to the intake line upstream of the compressor and is connected with its second side to the flow line downstream of the compressor, characterized in that the bypass line (42, 43) is connected to the compressor line (28) between a compressing element (52) of the compressor (14) and the throttle valve (36), and in that said bypass line has at least one regulating element (48) which is designed in such a way that it allows only a flow around the compressing element (52) from its side located upstream to its side located downstream and prevents a flow from the downstream side of the compressing element (52) to the upstream side of the latter.

9. The exhaust gas turbocharger as claimed in claim 8, characterized in that the at least one regulating element (48) is pressure-controlled, and preferably only the pressures in the intake line (26) in the region upstream of the compressing element (52) and in the region between the compressing element (52) and the throttle valve (36) act on the at least one regulating element (48) for the control.

10. An internal combustion engine with an exhaust gas turbocharger, characterized in that the exhaust gas turbocharger (10) is designed according to one of claims 8 or 9.
